(19) United States
(12) Patent Application Publication
(10) Pub. No.: US 2008/0075824 A1
(43) Pub. Date: Mar. 27, 2008

(54) Treatment of Plant Juices, Extracts and Pigments

(75) Inventor: Heather L. Biehl, Burlington, KY (US)

Correspondence Address: FROST BROWN TODD, LLC, 2200 PNC CENTER, 201 E. FIFTH STREET, CINCINNATI, OH, 45202, US

(73) Assignee: Wild Flavors, Inc., Erlanger, KY (US)

(21) Appl. No.: 11/857,869

(22) Filed: Sep. 19, 2007

Related U.S. Application Data
(60) Provisional application No. 60/826,818, filed on Sep. 25, 2006.

(51) Int. Cl. A23L 1/22

(52) U.S. Cl. 426/534; 426/599

(57) ABSTRACT

Products containing juices and or extracts from Brassicaceae plants are notorious for their obnoxious odor. This odor is a result of the myrosinase-glucosinolate system found in the family of plants. The present invention relates to Brassicaceae products (particularly red cabbage pigments) and provides treatments using enzyme(s) and chromatography to prevent, or significantly reduce the formation of off-odors.

### BACKGROUND OF THE INVENTION

This application is related to and claims priority from U.S. Provisional Patent Application Ser. No. 60/826,818, filed Sep. 25, 2006, incorporated herein by reference.

Products containing juices and/or extracts from plants of the Brassicaceae and other families of the mustard-oil lade (see Rodman et al. American Journal of Botany 85 (7) 997- 1006 (1998)) are notorious for their obnoxious odor and taste. This odor is a result of the myrosinase-glucosinolate system found in these plants. The myrosinase enzyme present in this family of plants is released during cell disruption. Cell disruption can occur when the plant material is macerated during the extraction process or during cooking. Upon release, myrosinase begins to act on its substrate, glucosinolates. Myrosinase hydrolyzes glucosinolates into aglucone and D-glucose. The main aglucone formed is thiohydroxamate-O-sulphate. Thiohydroxamate-O-sulphate and other algucones are very unstable and immediately decompose into nitrites, thiocyanates, isothiocyanates or indoles. These compounds are responsible for the offensive odor associated with Brassicaceae products. Current efforts to address this issue include using heat to destroy the myrosinase enzyme and using filtration processes to remove sulfur-containing compounds. The present invention provides a way to prevent, or significantly reduce, the formation of off-flavors related to the myrosinase-glucosinolate system in Brassicaceae products. These products can be extracts, pigments and juices.

The basic chemistry of the odor formation, as described above, can be summarized follows:

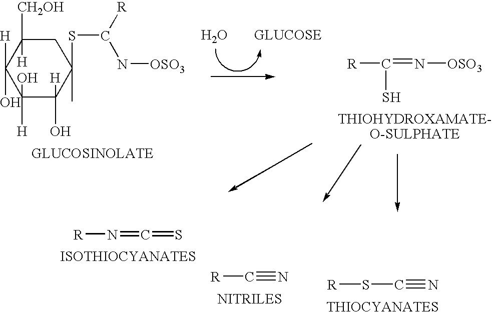

The identities of R in the predominant glucosinolates of a number of vegetables are as follows:

| | | |
|---|---|---|
| CABBAGE | 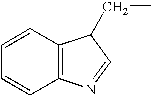 | INDOYLMETHYL |
| OTHER BRASSICASHORSERADISH,BLACK MUSTARD | 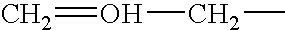 | ALLYL |
| WHITE MUSTARD | 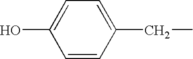 | P-HYDROXYBENZYL |
| RAPE | 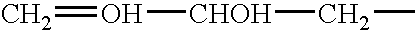 | 2-HYDROXYBUT-3-ENYL |
| WATERCRESS | 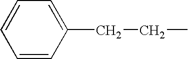 | 2-PHENYLETHYL |

### SUMMARY OF THE INVENTION

The present invention relates to mustard oil lade, especially Brassicaceae-derived, products (particularly red cabbage pigments) and provides treatments using enzyme(s) and chromatography to prevent or significantly reduce the formation of off-odor. The enzyme procedure involves using specific enzymes to attack the substrate of myrosinase. These enzymes may act on glucosinolates, or product of myrosinase due to the major activity or side activities, preventing the characteristic odor often associated with red cabbage. The chromatography procedure involves the use of two types of resin; one to remove the myrosinase enzyme and one to remove sulfur odor compounds. If all of the myrosinase is removed from red cabbage pigment, it cannot react with the glucosinolates to form the nitriles, thiocyanates, isothiocyanates or indoles. However, during the extraction of the pigment from red cabbage, some myrosinase has already acted, forming off-notes. Therefore, a second resin may optionally be used to remove already-developed odiferous compounds.

The deodorized juices, extracts or pigments made by this process, as well as food or beverage products including those juices, extracts or pigments as a flavoring agent, coloring agent, nutritive agent or functional agent are also encompassed by this invention.

### DETAILED DESCRIPTION OF THE INVENTION

The present invention relates to the treatment of Brassicaceae products, particularly (but not limited to) red cabbage pigments for use in food products such as beverages, which prevents or significantly reduces the formation of off-flavors and off-odors during the shelf life of the product. These treatments include a resin treatment (cation and anion exchange resins), an enzyme treatment (galacturonases, esterases and cellulases), or a combination of those treatments. The means of using the resins and enzymes will be familiar to those skilled in the art. These processing steps, as well as optional additional steps which may be included in the processes of the present invention, are described below.

The resins which may be used to extract the myrosinase enzyme and remove nitrites and sulfur-containing compounds include strong acid cation exchange resins, weakly basic anion exchanges resins, and mixtures thereof. Preferred resins for myrosinase extraction include those composed of sulfonic acid exchange sites on crosslinked polystyrene with a particle size ranging from about 0.600 mm to about 0.800 mm. Preferred resins for sulfur-containing compound adsorption include resins composed of tertiary amine functionality on suitable matrices, for example, macroreticular styrene-divinylbenzene matrix with a particle size ranging from about 0.490 mm to about 0.690 mm. When cation exchange resins are used the preferred resin is Amberlite® FPC22 H (Rohm and Haas/Ion Exchange Resins, Philadelphia, Pa., USA). When anion exchange resins are used the preferred resin is Amberlite® FPA51 (Rohm and Haas/Ion Exchange Resins, Philadelphia, Pa., USA). The procedure removes all or substantially all of the myrosinase enzyme.

The columns containing packed beds of resin can be comprised of glass and/or stainless steel. The physical dimensions of the columns and resin beds are such that suitable flow rates and pressure drops are achieved. Columns are operated in series; preferably the cation exchanger first, followed by the anion exchanger, under conditions recommended by the manufacturer of the resin. The maximum operating temperature of the column is preferably about 60° C. Preferred operating temperature is from about 20° C. to about 27° C. The flow rate of liquid through the column can be from about 2 to about 12 bed volumes per hour. Preferred flow rate is from about 2 to about 4 bed volumes per hour.

The eluant liquid may comprise water, preferably deionized, mixture of water and water miscible organic liquids, such as ethanol and ethyl acetate, in a single phase, or solutions of acids or bases in water. Selection of the preferred eluant liquid is dependent on the plant material being processed and the resin in use. Frequently, deionized water is the preferred eluant liquid.

The enzymes which may be used to act on glucosinolates or products of myrosinase action include commercial sources of galacturonases, esterases and cellulases, and mixtures thereof, typically of microbal origin. Preferred enzymes include ferulic acid esterase from Humicola sp., cellulase with ferulic acid esterase from Trichoderma and Aspergillus sp., and endogalacturonase from Aspergillus sp. Sources of the preferred enzymes include, for example, Macer8™, Depol™ 740L, Depol™ 692L (Biocatalysts Ltd., Parc Nantgarw Wales, UK) and combinations thereof. Enzymes can be dosed at from about 250 ml per ton up to about 2% by weight. Optimum pH ranges are from about 3.0 to about 6.0; preferably from about 4.0 to about 5.0, or as specified by the enzyme manufacturer. Working temperature range is generally from about 40° C. to about 65° C., and the mixture is held for a maximum of from about 8 hours to about 16 hours. Preferred conditions are temperature of about 55° C. to about 60° C. held from about 1 hour to about 8 hours.

Additional processing steps can be performed to obtain the desired end product. The pigment, extract or juice can be concentrated by, for example, vacuum distillation using about 40 mm Hg to about 50 mm Hg and temperature from about 22° C. to about 50° C., or other conditions of pressure and temperature in suitable stills such as short path length stills, as known to those practiced in the art.

It may be desirable to alter the pH of the deodorized pigment, extract and juice, specifically when working with pigments, extracts, and juices containing, for example, red cabbage. The pH may be adjusted using a dilute food grade acidic or caustic solution.

Red cabbage pigment itself may be manufactured, for example, as follows: Macerate cabbage and add deionized water. Heat to from about 40° C. to about 50° C. Use dilute sulfuric acid to adjust the pH of the slurry to from about 2 to about 3. Processing enzymes, for example, pectinase can be added up to about 250 ppm to aid in the extraction of color from the plant material. The slurry is pressed to separate the liquid from the solid plant material. Further filtration is performed to clarify the pigment. The product may be concentrated if desired.

The following examples are provided to illustrate the invention and are not intended to limit the scope thereof in any manner.

### EXAMPLE 1

After the manufacturing procedure described above, the following processing steps are performed using a red cabbage pigment. The cation exchange and anion exchange resins are loaded in two separate columns. The resin is activated according to manufacturer's instructions using a series of caustic and acidic rinses. The deodorization is carried out by introducing the aqueous red cabbage pigment into the chromatographic column including a cation exchange resin bed and continuing to pass the pigment solution through the chromatographic column until the discharge from the column outlet is of similar color to the feed entering the column, whereupon the feed is stopped. Elution of the pigment is carried out by passing deionized water into the chromatographic column including a cation exchange resin and the bound pigment and continuing to pass the deionized water through the column until at least one bed volume has been passed and the eluate is minimally colored. Red cabbage pigment that has passed through the column is considered “pretreated.”

Deodorization is completed by passing the aqueous “pretreated” pigment solution into the chromatographic column containing anion exchange resin and continuing to pass the pigment solution through the chromatographic column until the resin bed is saturated with color, as indicated by the discharge from the column outlet being of similar color intensity to that entering the column. Elution of the red cabbage pigment is carried out by passing deionized water through the chromatographic column including an anion exchange resin bed and the pigment and continuing to pass deionized water through the chromatographic column until at least one bed volume has been passed and the eluate is minimally colored. Pigment that has passed through the column is considered “treated.”

Treated pigment is acidified by, for example, adjusting the pH using a 10% w/v sulfuric acid solution to from about 1 to about 3. The red cabbage pigment is then concentrated to the desired color unit value by vacuum distillation using a Rotavapor at 40 mm Hg, and from about 40° C. to about 50° C.

### EXAMPLE 2

Using the manufacturing procedure described above, the following processing steps are performed using a red cabbage pigment. The pH of the red cabbage pigment is increased to from about 4.0 to about 5.0 using a dilute food grade caustic solution. The pigment is dosed with Macer8™ and Depol™ 692L (cellulase and ferulic acid esterase from Trichoderma and Aspergillus sp. microorganisms). The enzyme is dosed at from about 1% to about 2% by weight and incubated for about 1 hour to about 2 hours at from about 55° C. to about 60° C. Pigment that has been incubated with enzyme is considered “enzyme treated.”

Enzyme treated red cabbage pigment is acidified by adjusting the pH using a 10% w/v sulfuric acid solution to from about 1 to about 3. The red cabbage pigment is then concentrated to the desired color unit value by vacuum distillation using a Rotavapor at 40 mm Hg, and from about 40° C. to about 50° C.

What is claimed:

1. A method for preparing a juice, extract or pigment from plants of the mustard-oil clade, that is odorless or has only a faint odor, by subjecting the juice, extract, or pigment to at least one of the following treatments: chromatography, enzyme, or combinations thereof.

2. The method according to claim 1 wherein the plants are Brassicaceae plants

3. The method according to claim 2 wherein the chromatography is carried out using column chromatography.

4. The method according to claim 3 wherein the chromatography uses cation exchange and anion exchange resins in series.

5. The method according to claim 4 wherein the cation exchange resin is used prior to the anion exchange resin.

6. The method according to claim 4 wherein the operating temperature of the chromatography columns is no greater than about 60° C.

7. The method according to claim 4 wherein the flow rate of the juice extract or pigment is from about 2 to about 12 bed volumes per hour.

8. The method according to claim 4 wherein the cation exchange resin is used to remove the myrosinase enzyme.

9. The method according to claim 8 wherein the cation exchange resin is composed of sulfuric acid exchange sites on crosslinked polystyrene.

10. The method according to claim 9, wherein the cation resin particle size is from about 0.600 mm to about 0.800 mm.

11. The method according to claim 4 where the anion exchange resin is used to remove sulfur-containing compounds.

12. The method according to claim 11 wherein the anion exchange resin is composed of tertiary amine functionality on a macroreticular styrene-divinylbenzene matrix.

13. The method according to claim 12, wherein the anion resin particle size is from about 0.490 mm to about 0.690 mm.

14. The method according to claim 2 wherein the enzymes are selected from galacturonases, esterases, cellulases, and mixtures thereof.

15. The method according to claim 14 wherein the enzymes are used to alter glucosinolates or products arising from myrosinase action.

16. The method according to claim 14 wherein the enzymes are derived from the following microorganisms: Humicola sp., Trichoderma sp, Aspergillus sp., or mixtures thereof.

17. The method according to claim 14 wherein the enzymes are dosed at about 250 ml per ton up to about 2% by weight.

18. The method according to claim 14 wherein the mixture of enzymes with juice/extract/pigment is incubated, and the incubation is carried out at the optimum pH for the enzyme.

19. The method according to claim 14 wherein the extracts to be treated are incubated with the enzymes at from about 40° C. to about 65° C.

20. The method according to claim 19 wherein the extracts to be treated are incubated for a maximum of about 16 hours.

21. The method according to claim 2 wherein the treated juice, extract, or pigment is further processed to obtained a specific color hue, color intensity and/or color unit value.

22. The method according to claim 21 wherein the color hue is altered by adjusting the pH by using dilute food grade caustic or basic aqueous solution.

23. The method according to claim 21 wherein the color intensity and color unit value is altered by concentration, under conditions that result in no degradation of color.

24. Juices, extracts and pigments prepared by the method according to claim 2.

25. Food or beverage products which include the juices, extracts or pigments of claim 24 as flavoring, coloring, nutritive agents, or functional ingredients.
